(19) United States
(12) Patent Application Publication
(10) Pub. No.: US 2021/0088341 A1
(43) Pub. Date: Mar. 25, 2021

(54) SHUTTLE ROUTING SYSTEM

(71) Applicant: Ford Global Technologies, LLC, Dearborn, MI (US)

(72) Inventors: Perry MACNEILLE, Dearborn, MI (US); Jeffrey YEUNG, Dearborn, MI (US); Patrick Lawrence Jackson VAN HOECKE, Dearborn, MI (US); Oleg GUSIKHIN, Dearborn, MI (US); Ayush SHAH, Dearborn, MI (US)

(21) Appl. No.: 16/772,201

(22) PCT Filed: Dec. 18, 2017
(86) PCT No.: PCT/US2017/067113

§ 371 Date: Jun. 12, 2020

(51) Int. Cl. G01C 21/34; G06Q 50/30

(52) U.S. Cl. CPC G01C 21/343; G06Q 10/06; G01C 21/3438; G06Q 50/30

(57) ABSTRACT

Riders may request rides from a rider location to a desired destination. Possible stops are selected according to a fairness calculation that accounts for distance, weather, and wait times. Stops may be selected from among predefined virtual stops and based on virtual curb colors defining permitted stopping locations. Stops may be moved to promotional locations or to avoid stop congestion due to too many shuttles or too many riders using the stop. Routes are calculated for these stops and ETAs for the routes calculated based on traffic congestion data. Stop locations are communicated to riders and updated based on current traffic conditions or change in rider locations.

### BACKGROUND

### Field Of The Invention

This invention relates to operation of a shuttle for conveying multiple passengers.

### Background Of The Invention

Shuttle bus services compete with local transit authorities using large buses (-66 passengers) and individual transportation (taxis, personal vehicles, etc.). The cost of the driver per rider and lack of subsidies put these services at a cost disadvantage that is overcome using slightly higher fares, greater comfort, the convenience of mobile apps, and semi-flexible routes that attract more business. Where larger bus services stay on the same route so riders can learn where the stops are and the buses actual arrival time, shuttle services may change their routes in real-time to meet the changing needs of their riders. A critical customer satisfaction issue for shuttle services is meeting the estimated time of arrival (ETA) promises made by their mobile apps.

The system and methods disclosed herein provide an improved approach for implementing a shuttle service.

### BRIEF DESCRIPTION OF THE DRAWINGS

In order that the advantages of the invention will be readily understood, a reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a schematic block diagram of components implementing an autonomous vehicle for use in accordance with an embodiment of the present invention;

FIG. 1B is a schematic block diagram of components for implementing shuttle stop coordination in accordance with an embodiment of the present invention;

FIG. 2 is a schematic block diagram of an example computing device;

FIG. 3 is a process flow diagram of a method for coordinating shuttle stops in accordance with an embodiment of the present invention;

FIG. 4 is a diagram illustrating the coordination of shuttle stops in accordance with an embodiment of the present invention; and

FIG. 5 is a process flow diagram of a method for identifying fair stop locations for a shuttle in accordance with an embodiment of the present invention.

### DETAILED DESCRIPTION

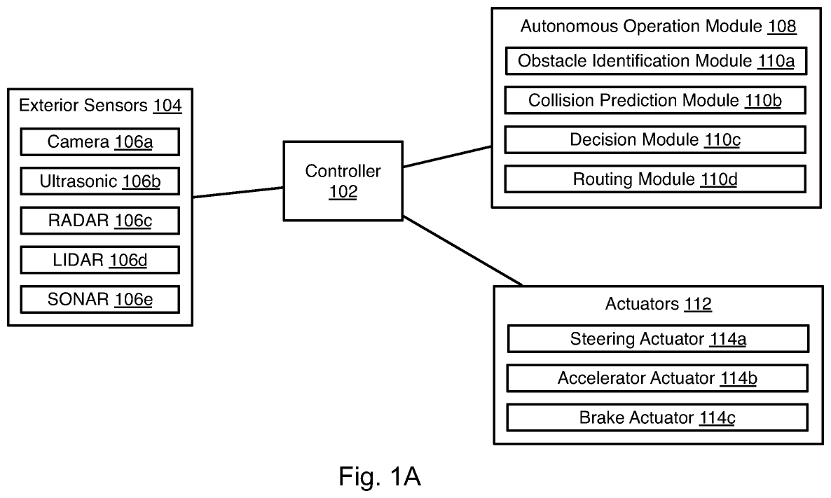

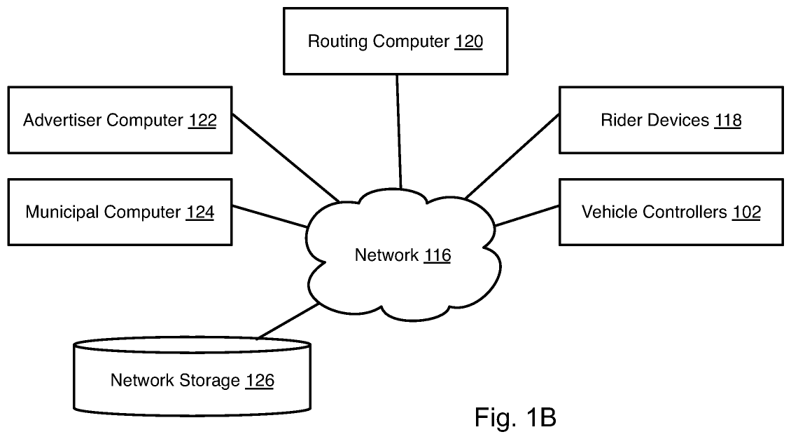

Referring to FIG. 1A, a vehicle used according to the methods disclosed herein may be may be a small capacity vehicle, such as sedan or other small vehicle or a large capacity vehicle such as a truck, bus, van, large sport utility vehicle (SUV), or the like. The methods described herein are particularly suited for a shuttle service that coordinates picking up and dropping off multiple passengers. Accordingly, a larger capacity vehicle such as a van or small bus is particularly suited for use according to the methods described herein. However, a multi-passenger vehicle of any size may also benefit from these methods.

The vehicle may have all of the structures and features of any vehicle known in the art including, wheels, a drive train coupled to the wheels, an engine coupled to the drive train, a steering system, a braking system, and other systems known in the art to be included in a vehicle.

As discussed in greater detail herein, a controller 102 of the vehicle may perform autonomous navigation and collision avoidance. The controller 102 may receive one or more outputs from one or more exterior sensors 104. For example, one or more cameras 106a may be mounted to the vehicle and output image streams received to the controller 102.

The exterior sensors 104 may include sensors such as an ultrasonic sensor 106b, a RADAR (Radio Detection and Ranging) sensor 106c, a LIDAR (Light Detection and Ranging) sensor 106d, a SONAR (Sound Navigation and Ranging) sensor 106e, and the like.

The controller 102 may execute an autonomous operation module 108 that receives the outputs of the exterior sensors 104. The autonomous operation module 108 may include an obstacle identification module 110a, a collision prediction module 110b, and a decision module 110c. The obstacle identification module 110a analyzes the outputs of the exterior sensors and identifies potential obstacles, including people, animals, vehicles, buildings, curbs, and other objects and structures. In particular, the obstacle identification module 110a may identify vehicle images in the sensor outputs.

The collision prediction module 110b predicts which obstacle images are likely to collide with the vehicle based on its current trajectory or current intended path. The collision prediction module 110b may evaluate the likelihood of collision with objects identified by the obstacle identification module 110a. The decision module 110c may make a decision to stop, accelerate, turn, etc. in order to avoid obstacles. The manner in which the collision prediction module 110b predicts potential collisions and the manner in which the decision module 110c takes action to avoid potential collisions may be according to any method or system known in the art of autonomous vehicles.

The decision module 110c may control the trajectory of the vehicle by actuating one or more actuators 112 controlling the direction and speed of the vehicle. For example, the actuators 112 may include a steering actuator 114a, an accelerator actuator 114b, and a brake actuator 114c. The configuration of the actuators 114a-114c may be according to any implementation of such actuators known in the art of autonomous vehicles.

In embodiments disclosed herein, the autonomous operation module 108 may perform autonomous navigation to a specified location, autonomous parking, and other automated driving activities known in the art.

The autonomous operation module 108 may cooperate with a server system executing the method disclosed herein or may itself perform the shuttle coordination methods described herein. Accordingly, a routing module 110d may be included in the autonomous operation module 108 that one or both of receives routing instructions from a server system executing the methods descried herein or determining a route according to the methods described herein.

Note that in some embodiments, vehicles that are human operated may also be routed according to the methods disclosed herein. Accordingly, instructions from the routing module 110d may be displayed to the operator of the vehicle for execution rather than being executed autonomously.

Referring to FIG. 1B, in practice, vehicle controllers 102 may be coupled to a network 116, such as by means of a cellular data connection or some other wireless data communication approach. Rider devices 118 of people using a shuttle service according to the methods described herein may also connected to the network 116 and may be embodied as mobile phones, tablet computers, wearable computers, or other computing devices. The rider devices 118 and vehicle controllers 102 preferably have the capacity to determine their positions, such as by means of a Global Positioning System (GPS) receiver.

A routing computer 120, such as a server system, may also be coupled to the network 116 and implement the shuttle routing methods described herein. As discussed below, the routing computer 120 may process ride requests from the rider devices 118, route vehicle controllers 102, and further make decisions with respect to promotional data from advertiser computers 122 and regulatory data from municipal computers 124. Other data such as weather and traffic data may also be obtained from computer systems making such data available over a network 116, such as the Internet or other wired or wireless network.

Data used to implement the methods described herein may be stored in network storage 126 that is accessible by one or more of the computing devices 102, 118-124. Alternatively, the network storage 126 may be a storage device local to the routing computer 120 and accessible by the computing devices 102, 118, 122, 124 over the network 116 by way of the routing computer 120.

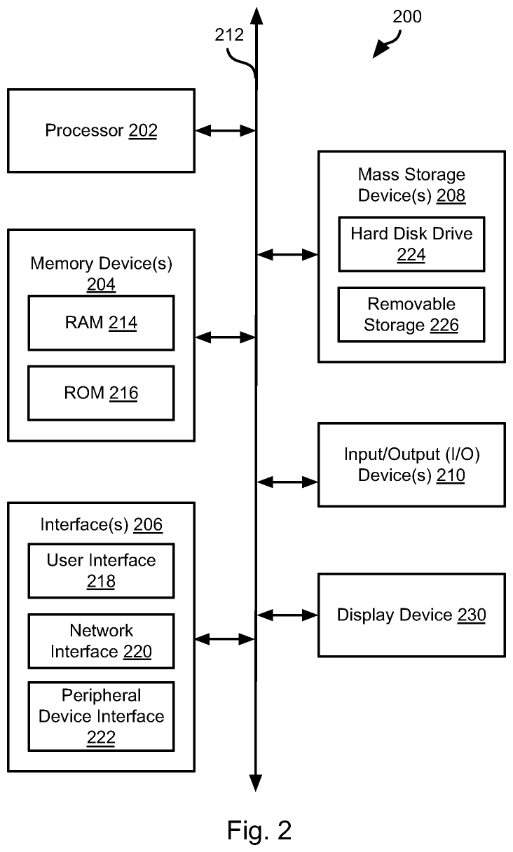

FIG. 2 is a block diagram illustrating an example computing device 200. Computing device 200 may be used to perform various procedures, such as those discussed herein. The vehicle controller 102, rider devices 118, routing computer 120, advertiser computer 122, municipal computer 124, and network storage 126 may have some or all of the attributes of the computing device 200.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

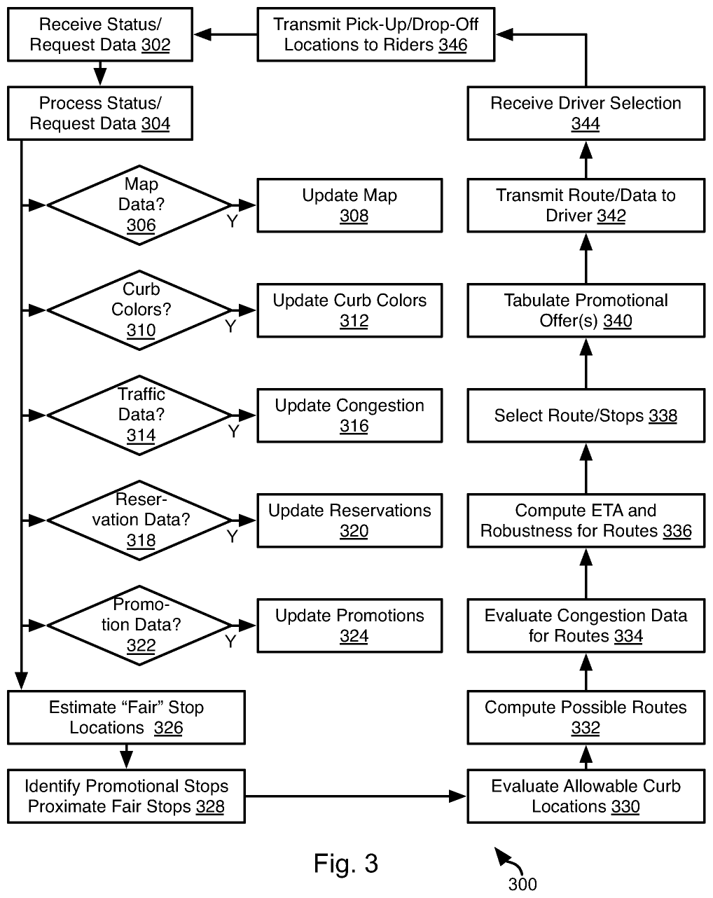

Referring to FIG. 3, the illustrated method 300 may be executed by the routing computer 120 with respect to the other computing devices of FIG. 1B. The method 300 may include receiving 302 status information and request data from a plurality of rider devices 118. Status information may include a location of the rider device 118 and request data may include a request to be picked up and a desired drop-off location. Request data may also include a desired time of arrival at the drop-off location.

Step 302 may further include receiving updated information from an advertiser computer 122 regarding promotions, a municipal computer 124 regarding permissible stop locations, and weather and traffic data from a server system providing such information.

Step 302 represents receiving data from various sources and may be performed over a period of time. As shown in FIG. 3, step 302 may continue to be executed throughout execution of the method 300 as any of the above-described types of information are changed or updated.

The data received at step 302 may then be processed 304 according to steps 306-324. The data of step 302 may include map data, such as data describing currently routable roads. In the field of autonomous vehicles, very detailed maps may be used with much finer-detailed routing data. Accordingly, map data 306 may include such maps for use by an autonomous vehicle. Accordingly, upon receiving such data, map data used by the routing computer 120 may be updated 308, such as in the network storage 126.

If the data of step 302 is found 310 to include curb color data, then curb color data may be updated 312, such as in the network storage 126. Various colors are painted on curbs to indicate the type of parking permitted at that curb. The meaning of the colors varies by municipality. The following is a listing of common meanings:

Red=no parking

Blue=handicap parking

White=passenger load and unload only

Yellow=passenger load and unload and freight unloading only

Green=limited time parking.

In some embodiments, a municipality may define virtual curb colors that define parking permissions at various locations in a city. These virtual curb colors may then be changed by the municipality based on traffic conditions. For example, where traffic is congested, loading and unloading on certain streets may be forbidden temporarily. When congestion clears, loading and unloading may again be permitted. A municipal computer 124 may therefore adjust these virtual curb colors and transmit changes to the routing computer 120 or otherwise make the current virtual curb colors available for access by routing computers 120 and other users of a transportation system.

In some embodiments, the virtual curb colors at a given location may be displayed on a screen to a human operator of a shuttle as the shuttle passes by that given location. This display may be updated in real time in response to changes in the virtual curb colors.

If data of step 302 is found 314 to include traffic data, then congestion data may be updated 316 according to the traffic data. The traffic data may include any electronic traffic alerts known in the art, e.g. any data collected by human or automated means that indicates the speed of traffic or the presence of vehicles at a particular location.

If the data of step 302 is found 318 to include reservation data, then reservations are updated 320. Reservation data may include a request for a ride including a current location of the rider and a desired drop-off location. The request for a ride may indicate a desired pick-up location as well as, or as an alternative to, the rider's current position. Reservation data of step 318 may include a new request for a ride or a change to a previous request for a ride. For example, where a previous request included a rider's current location, the routing computer 120 may continue to receive updates to the rider's current location as the rider moves around. The request from the rider may then be updated to include the new current location of the rider in response to each update.

If the data of step 302 is found 322 to include promotion data, then promotions may be updated 324 by the routing computer 120. As described in greater detail below, a business may pay to have riders picked up or dropped off at a promotional location, e.g. in front of a store, at a current location of a food truck, or other desired location. Accordingly, promotion data may indicate such a promotional location and may include other terms such as an amount of payment per rider, an amount of payment per purchase amount by a rider, or the like. Promotion data may also include an advertisement, coupon, or other offer that is transmitted by the routing computer 120 to a rider device 118 either before or after arriving at the promotional location.

In some instances, a promotional location may be very busy and may notify the routing computer 120 of this fact. Accordingly, a promotional location may be suspended in response to such a notification or moved to a different place of business as indicated by such a notification.

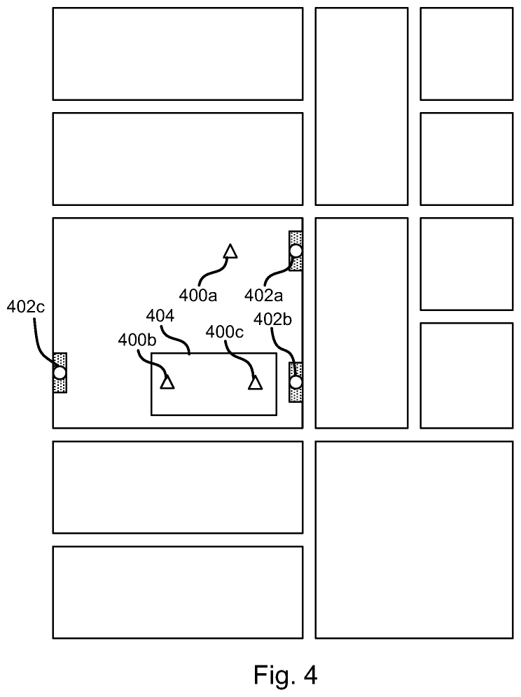

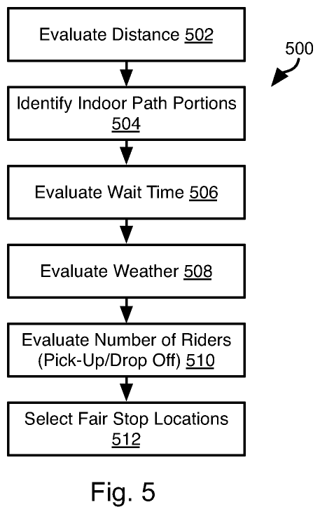

The method 300 may include estimating 326 fair stop locations (drop-off or pick-up locations) for the ride requests of step 318. In particular, each drop-off and pick-up location of each request may not operate as a constraint. Instead, a range of possible drop-off and pick-up locations may be possible. Stop locations for multiple passengers may be combined in order to improve efficiency of operation of a shuttle. Accordingly, fairness considerations may evaluate the walking and other inconvenience imposed on each passenger for a given combined stop location. A detailed method for determining fairness is described below with respect to FIGS. 4 and 5. Note that step 326 may identify multiple potential stops corresponding to the same drop-off and/or pick-up location. For example, step 326 may score the fairness of potential stops for a given drop-off or pick-up location but retain multiple stops for consideration according to subsequent steps of the method 300, rather than selecting the stop with the highest fairness score. For example, the top N stops for one or more drop-off and pick-up locations may be selected for further consideration while other stops are removed from consideration. As alternative, those stops with fairness scores above a threshold may be retained and those below the threshold may be removed from consideration.

The method 300 may further include identifying 328 promotional locations within a threshold proximity to the fair stops identified at step 326. For example, the fair stop locations may be evaluated with respect to a database of promotional locations and those within threshold proximity may be identified. The threshold proximity may indicate a permissible amount of inconvenience to a rider caused by the promotional location and may include distance from the fair stop, weather conditions expected at the fair stop at an expected time of arrival at the fair stop, an amount of the path between the promotional location and the fair stop that is indoors, and other considerations of inconvenience to a person. Accordingly, a score for a promotional stop based on some or all of these factors may be calculated and compared to a threshold. When this score is below the threshold, then the promotional location may be retained as a possible stop.

The method 300 may further include evaluating 330 the stops as defined after step 328 with respect to allowable curb locations. Those stops that are at currently impermissible locations may be eliminated or moved, e.g. to a closest permitted curb location. As noted above, allowable curb locations may be defined according to virtual curb colors received at step 310.

The method 300 may include computing 332 possible routes. In particular, possible routes for one or more shuttle vehicles may be generated that traverse stops as defined following step 332. In particular, routes that pass by the stops corresponding to the pick-up location and drop-off location of each ride request, with the pick-up location passed first, may be identified according to routing data. The manner in which a route traversing a predetermined set of stops is identified may be performed according to any routing algorithm known in the art.

Step 332 may include identifying many sets routes for multiple shuttles such that each set of routes passes by all of the stops with stops corresponding to the pick-up and drop-off locations for the same ride being traversed in that order by the same shuttle. As noted above, the result of step 326 may include multiple stops corresponding to the same pick-up or drop-off location. Accordingly, many sets of routes may be generated at step 332 that each include one of these multiple stops for that pick-up or drop off location such that stops corresponding to each pick-up and drop-off location of each ride request are traversed by at least one route of each set of routes in the correct order. Where the method 300 is executed for a single shuttle, possible routes may be generated that each traverse one stop of the multiple stops for each pick-up or drop-off location that has multiple possible stops.

The method 300 may further include evaluating congestion data 334 for each route of each set of routes. This may include evaluating traffic speed along each route for a single shuttle or each route of each set of routes for multiple shuttles. Step 334 may further include evaluating shuttle traffic at each stop of each route of each set of routes. For example, a set of routes may have multiple routes stopping at the same stop at or near the same time, e.g. within a threshold time period from one another. Accordingly, stops within the threshold time period at the same location among the set of routes may be identified at step 334.

The method 300 may further include computing 336 an estimated time of arrival (ETA) and robustness for each route of each possible route generated at step 332. Where the method 300 is executed with respect to multiple shuttles, each route of each set of routes may be evaluated for ETA and robustness. The ETA may be a function of congestion (traffic and stop co-use) as determined at step 334. In particular, traffic speed along a route may be considered to estimate the ETA as well as estimated delay based on co-use of a stop. The ETA may be an estimated time of arrival at a last stop in a route. Robustness refers to sensitivity to variation and uncertainty in the route, e.g. possible delays in traffic, left hand turns, delays in boarding or exiting a vehicle, or the like. An example algorithm for evaluating robustness of a route is described in “Optimal routes for electric vehicles facing uncertainty, congestion, and energy constraints,” Mathew William

Fontana, Massachusetts Institute of Technology (2013), which is hereby incorporated herein by reference in its entirety.

Step 336 may assign scores to each route of possible routes for a single shuttle according to the ETA and robustness determined for each route, such as by a function of these two values. For example, a score for a route may increase with increasing robustness and increase with earliness of the ETA, with a higher score indicating higher desirability. For a set of routes, an aggregate score of the scores for individual routes in the set may be calculated.

The method 300 may then include selecting 338 a route for a single shuttle according to the scores of step 336 or selecting a set of routes for multiple shuttles according to the aggregate score for the set of routes. For example, route with the highest score or the set of routes with the highest aggregate score may be selected.

The method 300 may further include tabulating 340 promotional offers for the selected route or set of routes. In particular, each promotional stop included in the selected route or set of routes may be identified and tabulated. Once a passenger is picked up or dropped off at one of these promotional stops, an electronic transfer of payment may be made to an entity associated with the shuttle or shuttles from a business requesting the promotional stop. For each promotional stop tabulated at step 340, an offer (e.g., coupon) associated with the promotional stop may be transmitted to riders corresponding to the ride request that corresponds to that promotional stop.

In some embodiments, a business that provides a promotion may further invoke electronic transfer of payment to the entity associated with the shuttle or shuttles in response to redemption of the offer or other purchases by a rider that is dropped off or picked up at the promotional stop.

The method 300 may further include transmitting 342 a route to a driver of a shuttle, e.g., a driver of a single shuttle or one of the shuttles that are implementing a set of routes. Where the shuttles are autonomous, the shuttle may be transmitted to the controller 102 of the shuttle or shuttles.

Where the shuttle or shuttles are driven by human operators that are independent, the driver may select a route to execute among possible routes selected at step 338. This selection may then be received 344 by the routing computer 120.

The methods described herein provide the driver of a shuttle with a set of good choices for stops and numerical estimates and enable the driver to make good choices. This may be the case where the shuttle operates at least semi-autonomously and the driver has time to evaluate these choices that along with drive the vehicle. If the shuttle is not autonomous, the driver will need help making decisions. In such cases, the stop location decision to be made remotely as in the case of an autonomous vehicle. If the shuttle is fully autonomous and there is no driver aboard the judgement about which stop to use, the selection of step 344 may be performed by a human at a remote location or by an artificial intelligence algorithm.

For a human or autonomous vehicle, events during execution of a route may necessitate a change in a stop location. In some embodiments, driver or autonomous vehicle may make a change to a stop in an already-accepted and currently executed route. Accordingly, this change may be communicated from a computing device of the shuttle to the rider device 118 of the affected rider and displayed on the rider device.

The method 300 may further include transmitting 346, to a rider device 118, locations of pick-up and drop-off locations determined according to the method 300 for the rider location and drop-off location specified in a ride request from a user associated with the rider device. As described above, this may include a “fair” location or corresponding promotional location as determined at steps 326 and 328 and as selected for inclusion in a route according to steps 330-338. The pick-up and drop-off locations may be transmitted with an intended time of arrival for each location based on expected shuttle speed according to the congestion data of step 334. The pick-up and drop-off locations may be presented in an application executing on the rider device and may be presented with navigation instructions informing the rider how to arrive at a pick-up location or travel from a drop-off location to a desired destination. The current location of the shuttle assigned to the rider's ride request may also be transmitted and displayed to the rider. If a pick-up or drop-off location is changed according to a subsequent iteration of the method 300, the rider may be informed of the change in the same manner. The rider may then proceed to the pick-up location by the time of arrival for the pick-up location in order to meet the shuttle.

The method 300 may be repeated continuously such that if, at any time, a rider position or desired drop-off location of a ride request is changed or a new ride request is received, the method 300 may be repeated into account for that change. Likewise, a rider may cancel a ride request thereby triggering recalculating to accommodate this change and avoid unnecessary stops. Repeated execution of the method 300 may also change in response to changes in virtual curb colors, changes in congestion data evaluated at step 334, or any other change in permissible stop locations. In particular, a route may change to avoid an accident or other congestion that was not present when a route was initially calculated and selected.

In some embodiments, the selection of stops may be constrained to a set of virtual stops rather than anywhere that stopping is permitted. This set of virtual stops may then be evaluated at step 326 to determine fair stops. Accordingly, where the locations of these virtual stops change, the method 300 may be repeated for the new set of virtual stops. In some instances, virtual stops may be selected near traffic lights such that a stop at a red light may be used as an opportunity to load or unload passengers without introducing additional delay. Such a stop may also be invoked dynamically when a red light is encountered within a threshold distance from an intended stop of a route.

FIGS. 4 and 5 illustrate example approaches for determining fair stop locations. Referring specifically to FIG. 4, various riders at locations 400a-400c may request rides from their current locations and various stops 402a-402c, such as pre-defined virtual stops, may be available for the riders that are at various distances from the stops 402a-402c. Locations 400b, 400c may be inside a structure 404, e.g. a mall or office building. Accordingly, the path to stop 402b for riders 400c and 400b includes traversing the interior space of the structure 404. Current and expected weather conditions along the paths to the stops 402a-402c from the rider locations 400a-400c may be obtained from weather prediction data.

Referring to FIG. 5, the fairness of stops configurations, such as stops 402a-402c may be evaluated according to the illustrated method 500. The method 500 may be executed as step 326 of the method 300. The method 500 may evaluate various stop configurations that include a stop 402a-402c and one or more riders that are assigned to that stop. Accordingly, there may be multiple stop configurations wherein riders are distributed among the stops 402a-402c in various ways and each of these configurations may be evaluated for fairness according to the method 500.

Each stop configuration may therefore be understood to include an assigned stop and one or more assigned riders each with an assigned rider location from which the rider must walk to reach the assigned stop. An assigned rider location may also indicate a rider's desired destination. Accordingly, the rider must walk from the assigned stop to the assigned rider location in that case. In the description below, multiple assigned riders are assumed but the method functions in an identical manner where a single rider is considered for a particular stop configuration.

For each stop configuration, the method 500 may include evaluating 502 a distance from an assigned rider location to the assigned stop. This distance may take into account obstacles indicated in map data in order to indicate a shortest walking path from the assigned locations to the assigned stop. In some instances, multiple paths may exist, accordingly, multiple distances may be calculated for these multiple paths for the same assigned location and the distance for the shortest path selected for consideration according to the method 500.

The score for each stop configuration may be updated according to the distance, e.g., the score may increase with decrease in distance where a higher score indicates greater desirability. In some embodiments, a degree of elevation change of a path may also be considered with the score increasing with decrease in an amount of elevation changes along the path.

For each stop configuration, the method 500 may further include identifying 504 portions of each path from step 502 that are indoors, such as from map data that indicates the locations of structures 404.

The method 500 may include evaluating 506 one or more wait times for a particular stop configuration. For example, rider location 400c is very close to location 402b and location 400b is further away. Accordingly, if rider locations 400b and 400c were assigned to stop 402b, then the rider for location 402c will have to wait for the rider for location 400b to arrive before being picked up. Accordingly, assigning stop 402b to the riders of locations 400b, 400c may have a penalty according to the wait time for the rider of location 400c. The wait time may be estimated as a difference in path length (see step 502) divided by an estimated walking velocity, e.g. 2.5 miles per hour.

The score for each stop configuration may be updated according to the wait times, e.g., the score may increase with decrease in wait time where a higher score indicates greater desirability.

For each stop configuration, the method 500 may include evaluating 508 weather conditions. For portions of a path from step 502 that are not outdoors, the expected weather conditions during traversal of an assigned rider corresponding to that path may be evaluated. In particular, a ride request may be issued at time T1 with a requested pick-up time of T2. The weather at one or more points between these times may be retrieved from a weather database. In particular, given travel along a path between a location 400a-400c and stop 402a-402b and known values of times T1 and T2, an expected rider location along the path at points between T1 and T2 may be known and the corresponding weather conditions at those points may also be determined from the weather data.

Accordingly, for a particular path a degree of weather-related discomfort may be calculated based on weather conditions at points along the path, such as from extreme heat or cold, rain, snow, high winds or the like. For example, the degree of weather-related discomfort may increase with an amount of time and number of degrees above or below a comfortable range. The degree of weather-related discomfort may increase with an amount of time spent in precipitation and the intensity of the precipitation. The amount of weather-related discomfort may be determined based on an estimate of weather conditions from a virtual weather sensor in a shuttle that estimates local weather conditions by accessing weather data from a network-connected source for such data. For points of a path that are indoors, weather related discomfort may be assumed to be absent. Step 508 may further augment the degree of weather-related discomfort according to a wait time at a stop location and the weather conditions during that wait time.

For assigned rider locations that correspond to a destination, the times considered for evaluating weather conditions are reversed, with T1 being an estimated time of arrival at the assigned stop and T2 being an estimated time of arrival at the assigned rider location. The degree of weather-related discomfort while traversing the path between the assigned rider location and assigned stop may be determined according to weather data in the same manner as described in the preceding paragraph.

The score for each stop configuration may be updated according to the degree of weather-related discomfort, e.g., the score may increase with decrease in weather-related discomfort where a higher score indicates greater desirability.

For each stop configuration, the method 500 may include evaluating 510 the number of assigned riders. In particular, a number of assigned riders that are boarding and a number of assigned riders that are exiting may be determined for the stop configuration.

In some instances, thresholds may be applied. For example, up to a first threshold number of assigned riders, consolidation may expedite operation of the shuttle. Where the number of riders exceeds the threshold consolidation may result in delays. Accordingly, the score for the stop configuration may be reduced for having an excess number of riders, where a higher score indicates greater desirability.

In some instances, it may be desirable to separate a stop for riders to exit a shuttle from a stop for riders to board a shuttle. The method 500 may increase the score of stop configurations that separate exiting and boarding riders, where the number of exiting and boarding riders exceeds the first threshold or a different threshold.

Note that in some instances a particular rider, such as a user of a wheel chair, may have special needs that need to be taken into account. Accordingly, where such a user exists, only stop configurations meetings these special needs may be considered according to the method 500. Likewise, stops for that rider may be constrained to be individual rather than combined with one or more other riders.

The method 500 may then include selecting 512 one or more stop configurations according to the scores thereof. For example, the highest scoring stop configuration may be selected, the top N (N greater than one) scoring stop configurations may be selected, or all stop configurations exceeding a score threshold may be selected. A combination of these approaches may also be used, either the top N or those that exceed a threshold, whichever is greater.

In some embodiments, the factors evaluated in the preceding steps, or the score derived therefrom, may be used to select 512 a stop configuration using a fairness algorithm such as Max-Min Fairness, Jain's Fairness Index, Fairly Shared Spectrum Efficiency, Quality of Service (QoS) Fairness, or other fairness algorithm known in the art.

In some embodiments, a rider may pay a fee for greater convenience. Accordingly, only those stops meeting that level of convenience are considered for the pick-up and drop-off locations for that user. For example, where a higher score indicates higher desirability, only those scores above a threshold may be considered, where the threshold is higher than the threshold for those that do not pay a fee for the greater convenience.

In some embodiments, fitness of a rider may be considered, such that those less able to walk are assigned to stops that are closer. Again, this may be implemented by imposing a distance threshold on stops for that user or imposing a higher threshold that a score for a stop must meet to be acceptable.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor, e.g. a virtual sensor, may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising, by a computer:
receiving a plurality of pick-up requests, each including a rider location;
identifying, for the plurality of pick-up requests, one or more first pick-up locations according to proximity to the rider locations of the plurality of pick-up requests; and
moving at least one location of the one or more first pick-up locations to a first promotional pick-up location within a threshold distance from the first pick-up location.

2. The method of claim 1, further comprising:
evaluating the at least one location with respect to a database of promotional locations corresponding to businesses;
determining (a) that the promotional pick-up location is in the database of promotional locations and within the threshold distance from the at least one location; and
in response to determining (a), performing the moving of the at least one location of the one or more first pick-up locations to the first promotional pick-up location.

3. The method of claim 1, further comprising:
traveling to the one or more first pick-up locations by a vehicle; and
invoking electronic transfer of payment from an entity associated with the first promotional pick-up location to an entity associated with the vehicle.

4. The method of claim 1, wherein identifying the one or more first pick-up locations comprises:
identifying two or more candidate pick-up locations according to map data;
for each pick-up request of the plurality of pick-up requests
(a) evaluating a distance to each candidate pick-up location;
(b) evaluating current weather conditions at the rider location of the each pick-up request; and
selecting a pick-up location of the one or more first pick-up locations corresponding to the each pick-up request according to (a) and (b).

5. The method of claim 1, wherein identifying the one or more first pick-up locations comprises:
identifying two or more candidate pick-up locations according to map data;
for each pick-up request of the plurality of pick-up requests
(a) evaluating a distance to each candidate pick-up location;
(b) evaluating current weather conditions at the rider location of the each pick-up request;
(c) evaluating an extent of a path between each candidate pick-up location and the rider location of the each pick-up request that is indoors; and
selecting a pick-up location of the one or more first pick-up locations corresponding to the each pick-up request according to (a), (b), and (c).

6. The method of claim 1, wherein identifying the one or more first pick-up locations comprises:
identifying two or more candidate pick-up locations according to map data;
for each pick-up request of the plurality of pick-up requests
(a) evaluating a distance to each candidate pick-up location;
(b) evaluating an expected rider wait time at each candidate pick-up location;
(c) evaluating an estimated time of arrival for a route including each candidate pick-up location;
(d) evaluating current weather conditions at the rider location of the each pick-up request; and
selecting a pick-up location of the one or more first pick-up locations corresponding to the each pick-up request according to (a), (b), (c), and (d).

7. The method of claim 1, wherein identifying the one or more first pick-up locations comprises:
identifying two or more candidate pick-up locations according to map data;
for each pick-up request of the plurality of pick-up requests
(a) evaluating a distance to each candidate pick-up location;
(b) evaluating traffic congestion at each candidate pick-up location; and
selecting a pick-up location of the one or more first pick-up locations corresponding to the each pick-up request according to (a) and (b).

8. The method of claim 1, wherein identifying the one or more first pick-up locations comprises:
when a portion of the plurality of pick-up requests having locations within a threshold distance from a candidate pick-up location exceeds a rider number threshold, selecting multiple pick-up locations for the portion of the plurality of pick-up requests.

9. The method of claim 1, wherein the plurality of pick-up requests each further include a drop-off location, the method further comprising:
when a portion of the rider locations and the drop-off locations of the plurality of pick-up requests that are within a threshold distance of a candidate location is below a threshold, selecting the candidate pick-up location as a stop for the portion of the rider locations and the drop-off locations of the plurality of pick-up requests.

10. The method of claim 1, wherein the plurality of pick-up requests each further include a drop-off location, the method further comprising:
when a portion of the rider locations and the drop-off locations of the plurality of pick-up requests that are within a threshold distance of a first candidate location is above a threshold, selecting one of the first candidate location and a second candidate location as a pick-up location for the rider locations of the portion and selecting an other of the first candidate location and the second candidate location as a drop-off point for the drop-off locations of the portion.

11. A system comprising one or more processing devices and one or more memory devices operably coupled to the one or more processing devices, the memory devices storing executable code effective to cause the one or more processing devices to:
receive a plurality of pick-up requests, each including a rider location;
identify, for the plurality of pick-up requests one or more first pick-up locations according to proximity to the rider locations of the plurality of pick-up requests; and
change at least one location of the one or more first pick-up locations to a first promotional pick-up location within a threshold distance from the first pick-up location.

12. The system of claim 11, wherein the executable code is further effective to cause the one or more processing devices to:
evaluate the at least one location with respect to a database of promotional locations corresponding to businesses; and
when (a) the promotional pick-up location is in the database of promotional locations and within the threshold distance from the at least one location, perform the moving of the at least one location of the one or more first pick-up locations to the first promotional pick-up location.

13. The system of claim 11, further comprising a vehicle;
wherein the executable code is further effective to cause the one or more processing devices to:
instruct the vehicle to travel to the one or more first pick-up locations; and
invoke electronic transfer of payment from an entity associated with the first promotional pick-up location to an entity associated with the vehicle.

14. The system of claim 11, wherein the executable code is further effective to cause the one or more processing devices to identify the one or more first pick-up locations by:
identifying two or more candidate pick-up locations according to map data;
for each pick-up request of the plurality of pick-up requests
(a) evaluating a distance to each candidate pick-up location;
(b) evaluating current weather conditions at the rider location of the each pick-up request; and
selecting a pick-up location of the one or more first pick-up locations corresponding to the each pick-up request according to (a) and (b).

15. The system of claim 11, wherein the executable code is further effective to cause the one or more processing devices to identify the one or more first pick-up locations by:
identifying two or more candidate pick-up locations according to map data;
for each pick-up request of the plurality of pick-up requests
(a) evaluating a distance to each candidate pick-up location;
(b) evaluating current weather conditions at the rider location of the each pick-up request;
(c) evaluating an extent of a path between each candidate pick-up location and the rider location of the each pick-up request that is indoors; and
selecting a pick-up location of the one or more first pick-up locations corresponding to the each pick-up request according to (a), (b), and (c).

16. The system of claim 11, wherein the executable code is further effective to cause the one or more processing devices to identify the one or more first pick-up locations by:
identifying two or more candidate pick-up locations according to map data;
for each pick-up request of the plurality of pick-up requests
(a) evaluating a distance to each candidate pick-up location;
(b) evaluating an expected rider wait time at each candidate pick-up location;
(c) evaluating an estimated time of arrival for a route including each candidate pick-up location;
(d) evaluating current weather conditions at the rider location of the each pick-up request; and
selecting a pick-up location of the one or more first pick-up locations corresponding to the each pick-up request according to (a), (b), (c), and (d).

17. The system of claim 11, wherein the executable code is further effective to cause the one or more processing devices to identify the one or more first pick-up locations by:
identifying two or more candidate pick-up locations according to map data;
for each pick-up request of the plurality of pick-up requests
(a) evaluating a distance to each candidate pick-up location;
(b) evaluating traffic congestion at each candidate pick-up location; and
selecting a pick-up location of the one or more first pick-up locations corresponding to the each pick-up request according to (a) and (b).

18. The system of claim 11, wherein the executable code is further effective to cause the one or more processing devices to identify the one or more first pick-up locations by:
when a portion of the plurality of pick-up requests having locations within a threshold distance from a candidate pick-up location exceeds a rider number threshold, selecting multiple pick-up locations for the portion of the plurality of pick-up requests.

19. The system of claim 11, wherein the plurality of pick-up requests each further include a drop-off location, the executable code being further effective to cause the one or more processing devices to:
when a portion of the rider locations and the drop-off locations of the plurality of pick-up requests that are within a threshold distance of a candidate location is below a threshold, select the candidate pick-up location as a stop for the portion of the rider locations and the drop-off locations of the plurality of pick-up requests.

20. The system of claim 19, wherein the executable code is further effective to cause the one or more processing devices to:
when a portion of the rider locations and the drop-off locations of the plurality of pick-up requests that are within a threshold distance of a first candidate location is above a threshold, select one of the first candidate location and a second candidate location as a pick-up location for the rider locations of the portion and select an other of the first candidate location and the second candidate location as a drop-off point for the drop-off locations of the portion.
